(19) United States
(12) Patent Application Publication
(10) Pub. No.: US 2006/0148465 A1
(43) Pub. Date: Jul. 6, 2006

(54) System and method for providing an adaptive disablement zone

(76) Inventors: Jorge L. Perdomo, Boca Raton, FL (US); Wayne W. Ballantyne, Coconut Creek, FL (US); Daniel A. Baudino, Lake Worth, FL (US); Jose E. Korneluk, Boynton Beach, FL (US)

Correspondence Address: MOTOROLA, INC;INTELLECTUAL PROPERTY SECTION, LAW DEPT, 8000 WEST SUNRISE BLVD, FT LAUDERDAL, FL, 33322, US

(21) Appl. No.: 11/026,887

(22) Filed: Dec. 30, 2004

(51) Int. Cl. H04Q 7/20

(52) U.S. Cl. 455/422.1

(57) ABSTRACT

The invention concerns a method (400) and system (100) for providing an adaptive disablement zone (126). The method can include the steps of establishing (412) at least one disablement zone, selectively disabling (420) any number of wireless communications devices (114) in the disablement zone, designating (424) at least one exempt zone (128) and when at least a portion of the exempt zone is located within the disablement zone, selectively exempting (430) the selective disabling of the wireless communications devices that are within the exempt zone. The method can further include the step of maintaining (414) the disablement zone in a fixed position or moving (414) the disablement zone. The method can also include the step of maintaining (426) the exempt zone in a fixed position or moving (426) the exempt zone.

### BACKGROUND OF THE INVENTION

1. Field of the Invention

This invention relates in general to wireless communications devices and more particularly, to systems and methods for disabling the operation of such devices.

2. Description of the Related Art

In today's marketplace, consumers have numerous wireless communications devices, such as cellular telephones and personal digital assistants, from which to choose. As a result, these wireless devices have become ubiquitous. Unfortunately, there are many places where the operation of a wireless device may not be appropriate. For example, many courtrooms and churches have banned the use of cellular telephones while individuals are on those premises. As another example, several schools have expressed an interest in banning the use of cellular telephones on school campuses and in the school zones that surround such areas.

In response, several manufacturers have developed transmitters that can inhibit the receipt and transmission of wireless signals in a designated area. If they are deployed, such devices can help enforce the bans on cellular telephone use in these areas. These devices, however, enforce a sweeping ban on cellular telephone use within their operating ranges, and they may encompass areas where the use of wireless devices is acceptable or even necessary. This drawback is because the devices act as localized jamming units and thus, do not have a tightly-controlled operating area. In addition, these devices must operate at various frequencies to be able to suppress the communications of various types of mobile units.

In addition, some terrorists have used cellular telephones or other wireless devices to detonate explosives placed at a remote location. As an example, the ringer of the cellular telephone can be coupled to an electric triggering mechanism for the explosive device, which may detonate if a call is placed to the cellular telephone. These individuals may target public places, like public transportation stations, shopping malls or sporting events. Further, terrorists may target moving objects, such as one or more individuals riding in a motorcade. Stationary devices for blocking wireless transmissions, while useful for some locations, are not very helpful in protecting moving targets.

### SUMMARY OF THE INVENTION

The present invention concerns a method for providing an adaptive disablement zone. The method can include the steps of establishing at least one disablement zone, selectively disabling any number of wireless communications devices in the disablement zone and designating at least one exempt zone. The method can also include the step of—when at least a portion of the exempt zone is located within the disablement zone—selectively exempting the selective disabling of the wireless communications devices that are within the exempt zone. As will be explained below, the disabling of a wireless communications device can encompass complete disabling of all basic functions or only selective disablement of certain features. As an example, if a wireless communications device is selectively disabled, the device may retain the ability to receive a call but may not be allowed to initiate a call. As another example, the ringer for the wireless device may be disabled but the vibratory alert can remain enabled. The method can further include the step of acquiring positional information relating to the wireless communications devices in the disablement zone.

As an example, the establishing at least one disablement zone step can include the step of establishing the disablement zone based on positional information. The method can further include the step of comparing the positional information relating to the wireless communications devices to a coverage area of the disablement zone to determine whether the wireless communications devices are within the disablement zone. As another example, the designating at least one exempt zone step can further include designating the exempt zone based on positional information. The method can further include the step of comparing the positional information relating to the wireless communications devices to a coverage area of the exempt zone to determine if the wireless communications devices are within the exempt zone.

In one arrangement, the method can include the steps of maintaining the disablement zone in a fixed position or moving the disablement zone. Any number of disablement zones may be fixed and any number of disablement zones may be moving at a given time. The method may also include the steps of maintaining the exempt zone in a fixed position or moving the exempt zone. Any number of exempt zones may be fixed and any number of exempt zones may be moving at a given time. The method may also include the step of exempting predetermined wireless communications devices from being selectively disabled while in the disablement zone regardless of whether the predetermined wireless communications devices are within an exempt zone. As an example, the predetermined wireless communications devices that are exempted can be assigned to at least one of government officials and emergency personnel.

The method can further include the step of notifying users of the wireless communications devices of the selective disabling of the wireless communications devices. The method can also include the step of overriding the selective disabling of a wireless communications device if a user of the wireless communications provides an indication of an emergency condition.

The present invention also concerns a disablement zone manager. The disablement zone manager can include a communication interface for permitting the disablement zone manager to communicate with a communications network and a processor coupled to the communication interface. The processor can be programmed to establish at least one disablement zone, to cause via the communications network through the communication interface the selective disablement of any number of wireless communications devices in the disablement zone and designate at least one exempt zone. The processor can also be programmed to cause via the communications network through the communication interface the selective exemption of the selective disabling of the wireless communications devices that are within the exempt zone when at least a portion of the exempt zone is located within the disablement zone. The disablement zone manager can also include suitable software, including one or more suitable command sets, and circuitry for performing the processes described above.

The present invention also concerns a system for providing an adaptive disablement zone. The system can include a disablement zone manager and a communications network coupled to the disablement zone manager. The communications network can service wireless communications devices. The disablement zone manager can establish at least one disablement zone, signal the communications network to cause the selective disablement of any number of wireless communications devices in the disablement zone and designate at least one exempt zone.

The disablement zone manager can also—when at least a portion of the exempt zone is located within the disablement zone—signal the communications network to cause the selective exemption of the selective disabling of the wireless communications devices that are within the exempt zone. The system also can include suitable software and circuitry for performing the processes described above.

The present invention also concerns a wireless communications device. The device can include a transceiver that communicates with a communications network, a positional acquiring element that acquires positional information relating to the wireless communications device and a processor that can be coupled to the transceiver and the positional acquiring element. The processor can be programmed to determine when the wireless communications unit is in a disablement zone and in response, selectively disable at least one feature of the wireless communications device and determine when the wireless communications device is in an exempt zone.

The processor can also be programmed to selectively exempt the selective disabling of the features of the wireless communications device when the wireless communications device is in the exempt zone. The wireless communications device can determine that it is in a disablement zone or an exempt zone through an internal process or by receiving a disabling signal and an exempt signal (respectively) from a communications network. The wireless communications device can also include suitable software and circuitry for performing the processes described above.

### BRIEF DESCRIPTION OF THE DRAWINGS

The features of the present invention, which are believed to be novel, are set forth with particularity in the appended claims. The invention, together with further objects and advantages thereof, may best be understood by reference to the following description, taken in conjunction with the accompanying drawings, in the several figures of which like reference numerals identify like elements, and in which:

FIG. 1 illustrates a system for providing an adaptive disablement zone in accordance with an embodiment of the inventive arrangements;

FIG. 2 illustrates a movable disablement zone and a movable exempt zone in accordance with an embodiment of the inventive arrangements;

FIG. 3 illustrates a block diagram of a disablement zone manager and a wireless communications device in accordance with an embodiment of the inventive arrangements;

FIG. 4 illustrates a portion of a method for providing an adaptive disablement zone in accordance with an embodiment of the inventive arrangements; and

FIG. 5 illustrates another portion of the method of FIG. 4 in accordance with an embodiment of the inventive arrangements.

### DETAILED DESCRIPTION OF THE INVENTION

While the specification concludes with claims defining the features of the invention that are regarded as novel, it is believed that the invention will be better understood from a consideration of the following description in conjunction with the drawing figures, in which like reference numerals are carried forward.

As required, detailed embodiments of the present invention are disclosed herein; however, it is to be understood that the disclosed embodiments are merely exemplary of the invention, which can be embodied in various forms. Therefore, specific structural and functional details disclosed herein are not to be interpreted as limiting, but merely as a basis for the claims and as a representative basis for teaching one skilled in the art to variously employ the present invention in virtually any appropriately detailed structure. Further, the terms and phrases used herein are not intended to be limiting but rather to provide an understandable description of the invention.

The terms a or an, as used herein, are defined as one or more than one. The term plurality, as used herein, is defined as two or more than two. The term another, as used herein, is defined as at least a second or more. The terms including and/or having, as used herein, are defined as comprising (i.e., open language). The term coupled, as used herein, is defined as connected, although not necessarily directly, and not necessarily mechanically. The terms program, software application, and the like as used herein, are defined as a sequence of instructions designed for execution on a computer system. A program, computer program, or software application may include a subroutine, a function, a procedure, an object method, an object implementation, an executable application, an applet, a servlet, a source code, an object code, a shared library/dynamic load library and/or other sequence of instructions designed for execution on a computer system.

The invention concerns a method and system for providing an adaptive disablement zone. In one arrangement, the method can include the steps of establishing at least one disablement zone and selectively disabling any number of wireless communications units in the disablement zone. The method can also include the steps of designating at least one exempt zone and when at least a portion of the exempt zone is located within the disablement zone, selectively exempting the selective disabling of the wireless communications units that are within the exempt zone. In one arrangement, the disablement zone can be in a fixed position or can be moving. Similarly, the exempt zone can be in a fixed position or can be moving.

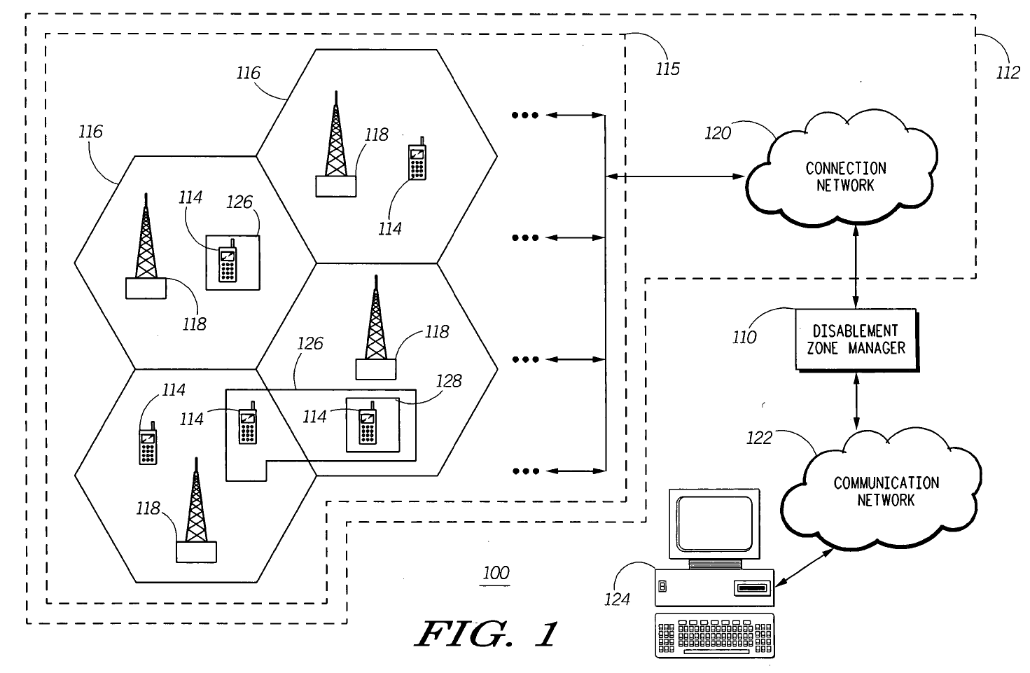

Referring to FIG. 1, a system 100 for providing an adaptive disablement zone is shown. In one arrangement, the system 100 can include a disablement zone manager 110, a communications network 112 communicatively coupled to the disablement zone manager 110 and one or more wireless communications devices 114. The wireless communications device 114 can be any portable unit capable of receiving or transmitting wireless signals, including but not limited to cellular telephones, two-way radios, etc. For brevity, the wireless communications devices 114 may also be referred to as wireless devices 114 or simply devices 114.

In one arrangement, the communications network 112 can include a wireless section 115, which can have one or more cells 116. The cells 116 can contain base stations 118. As is known in the art, the base stations 118 can wirelessly communicate with the wireless devices 114 using any suitable transmission protocols.

The communications network 112 can also include a connection network 120, which can transfer signals between the disablement zone manager 110 and the base stations 118. The connection network 120 can be the Public Switched Telephone Network (PSTN), the Internet or any other suitable network that is capable of transferring signals between the wireless section 115 and the disablement zone manager 110. It is understood that that disablement zone manager 110 can include its own communications network, such as radio transceivers, for transferring signals between it and the wireless devices 114, thereby circumventing the communications network 112, if so desired.

The disablement zone manager 110 can receive input from another communications network 122. As an example, one or more computing devices 124 can be communicatively coupled to the communications network 122. Through this configuration, users of the computing device 124 may be able to input information into the disablement zone manager 110. As an example, the communications network 122 can be the Internet or some other suitable network for transferring data from a computing device to the disablement zone manager 110. For purposes of the invention, the computing device 124 can be any component capable of receiving input from a user and transmitting that input to the disablement zone manager 110 through the communications network 122. In one arrangement, the communications network 122 can be separate from the connection network 120, although the communications network 122 may be the same entity as the connection network 120, as well.

In one arrangement, the disablement zone manager 110 can establish disablement zones 126. The disablement zones 126 can be, for example, any geographic area in which at least a portion of the operability of the wireless devices 114 can be suppressed or inhibited in some fashion. As an example, these disablement zones 126 can be established in areas where it may be desirable to inhibit wireless communications. As shown, the disablement zones 126 can be positioned entirely within the operating range of a cell 116, or they can extend into the operating range of one or more neighboring cells 116. To determine whether a wireless device 114 is located within a disablement zone 126, the disablement zone manager 110 can receive positional information relating to the wireless devices 114.

In another arrangement, the disablement zone manager 110 can establish or designate exempt zones 128. As an example, the exempt zones 128 can be any geographic area in which the operability of a wireless device 114 may be at least partially exempt from the selective disablement associated with the disablement zones 126. For example, the exempt zones 128 may be associated with areas where communications are vital, such as hospitals and police and fire stations. The exempt zones 128, including portions of the exempt zones 128, may or may not be located within a disablement zone 126. Similar to the disablement zones 126, the disablement zone manager 110 can receive positional information relating to the wireless devices 114 to determine whether the wireless devices 114 are located within an exempt zone 128. In one arrangement, the disablement zones 126 and the exempt zones 128 can be fixed. As another example, the disablement zones 126 and the exempt zones 128 can be movable.

The disablement zone manager 110 can be designed to serve multiple communications networks 112. For example, several different wireless carriers may provide their own wireless sections 115, each of which may or may not share the same connection network 120. In this arrangement, the disablement zone manager 110 can establish disablement zones 126 and designate exempt zones 128 for all the different networks that are provided by various wireless communications carriers.

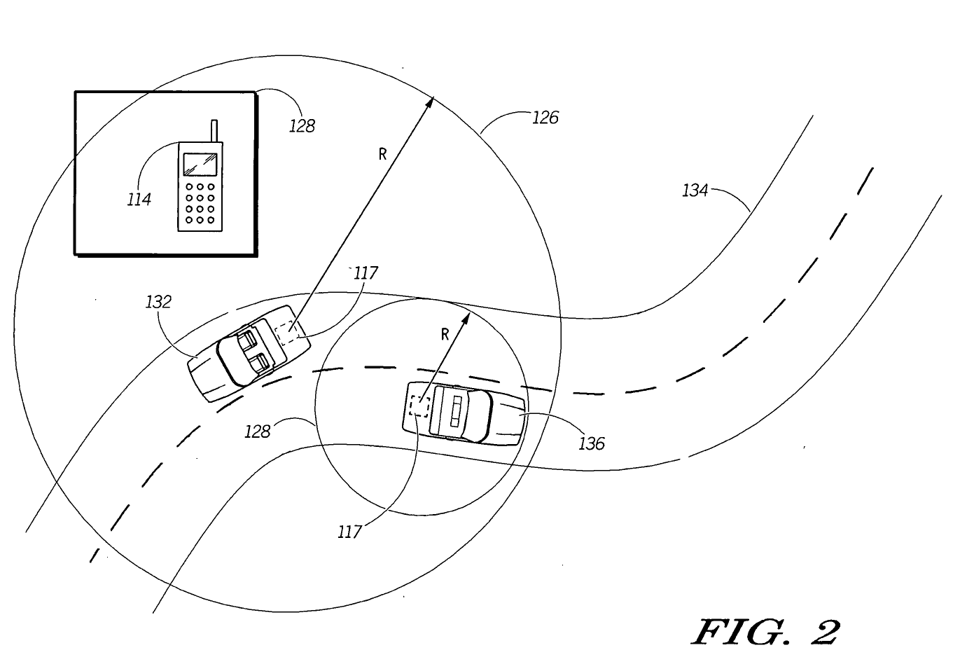

Referring to FIG. 2, another portion of the communications system 100 is shown. In this example, the disablement zone 126 can be movable. To describe FIG. 2, reference will also be made to FIG. 1. In particular, a wireless communications device 114 can be implemented in, for example, a vehicle 132. The vehicle 132 is shown driving on a road 134, of which at least a portion can be located within one or more of the cells 116. The wireless communications device 114 can communicate with the base stations 118 of the cells 116. This type of wireless device 114 can be used to help create the movable disablement zones 126 and may be referred to as a tracking wireless device 117. The tracking wireless device 117 may be structurally and operationally similar to the wireless devices 114, if so desired.

In this example, the disablement zone 126 can have a range R, which can be measured from the tracking wireless device 117 in the vehicle 132. The radius R can be any suitable value and can be measured in any suitable unit of measure, such as feet, yards, miles, etc. As the vehicle 132 moves, the disablement zone 126 can correspondingly move, as well. The wireless devices 114 that are locate within the disablement zone 126 can be selectively disabled while they are in the disablement zone 126. After the disablement zone 126 passes, the functionality of the wireless devices 114 can be restored.

The disablement zone manager 110 can be provided with the location of the tracking wireless device 117 located in the vehicle 132, which can enable the disablement zone manager 110 to continuously update the movable disablement zone 126. Although the disablement zone 126 is shown here in the shape of a circle having a radius R, it is understood that the invention is not so limited. In particular, the disablement zone 126 can have any other suitable shape having any suitable dimensions. For example, the disablement zone 126 may be a square or some other polygon with a predetermined number of vertices that are located a predetermined distance away from the tracking wireless device 117.

In one arrangement, if the disablement zone 126 passes through an exempt zone 128, the wireless devices 114 in the exempt zone 128 may not be selectively disabled. In another arrangement and as noted earlier, the exempt zone 128 may be movable. For example, an exempt zone 128 can be positioned around a vehicle 136, such as an emergency vehicle. As this exempt zone passes 128 passes through the disablement zone 126, the wireless devices 114 that may be in the movable exempt zone 128, such as those positioned inside the vehicle 136, can avoid having their functionality affected.

As an example, the movable exempt zone 128 can have a radius R, which can be any suitable value. Like the disablement zone 126, the radius R of the movable exempt zone 128 can be measured from a tracking wireless device 117 in the vehicle 136. It is understood, however, that the shape of the movable exempt zone 128 is not so limited and can be in other suitable forms. As an example, the exempt zone can be a polygon with a predetermined number of vertices that are located a predetermined distance away from the tracking wireless device 117.

To update the positioning of the movable exempt zone 128, the disablement zone manager 110 can be provided with the location of, for example, the tracking wireless device 117 located in the vehicle 136. In either of these arrangements, it must be noted that the invention is not limited to positioning movable disablement zones 126 and movable exempt zones 128 around vehicles. The movable zones 126 and 128 can be, for example, positioned around individuals, airplanes or boats. In fact, the movable zones 126 and 128 can be positioned around any movable object.

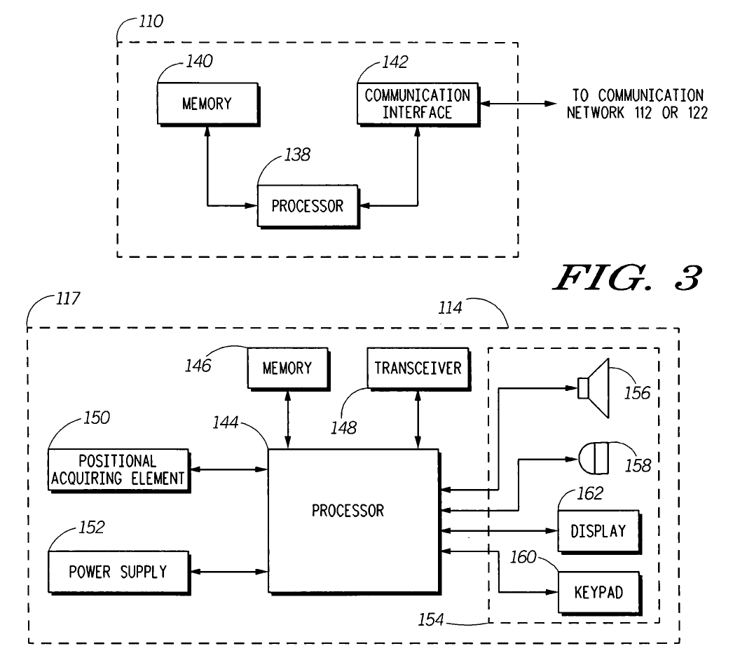

Referring to FIG. 3, a block diagram of an example of a disablement zone manager 110 and a wireless communications device 114 is shown. The block diagram for the wireless device 114 may also be applicable to the tracking wireless device 117. In one arrangement, the disablement zone manager 110 can include a processor 138, a memory or database 140 and a communications interface 142. The processor 138 can be communicatively coupled to both the memory 140 and the communications interface 142 and can control the operation of both.

The communication interface 142 can be any component capable of receiving data from the communications network 112 or 122 and transferring it to the processor 138 for further processing. The communications interface 142 can be configured to receive wireless signals or those passing over conventional hard-wired lines. The memory 140 can be used to store instructions to enable the processor 138 to carry out the inventive arrangements. The memory 140 can also store positional information relating to the disablement zones 126 and the exempt zones 128 (see FIGS. 1 and 2).

The wireless device 114 (or tracking wireless device 117) can include a processor 144, a memory 146, a transceiver 148, a positional acquiring element 150, a power supply 152 and a user interface section 154. The processor 144 can be communicatively coupled to and control the operation of the memory 146, the transceiver 148, the positional acquiring element 150, the power supply 152 and the user interface section 154. In one arrangement, the user interface section 154 can include a speaker 156, a microphone 158, a keypad 160 and a display 162.

The transceiver 148 can receive wireless signals from and transmit wireless signals to the base stations 118 in accordance with well-known principles. The memory 146 can store instructions that the processor 144 can access for operation. In one arrangement, the memory 146 can store positional information relating to the disablement zones 126 and the exempt zones 128. In addition, the positional acquiring element 150 can be any component, system or module that is capable of determining the physical location of the wireless device 114 (or the tracking wireless device 117). As an example but without limitation, the positional acquiring element 150 can be a global positioning system (GPS) receiver that can receive positional coordinates for the wireless device 114 (or the tracking wireless device 117) and can transfer them to the processor 144.

As is known in the art, the speaker 156 can broadcast audio, and the microphone 158 can capture audio and transfer it to the processor 144. The display 162 can display images to a user of the wireless device 114, and the user can enter information into the wireless device 114 (or the tracking wireless device 117) through the keypad 160. A user may also be able to enter information into the wireless device 114 through the display 162, if the display 162 is so configured. The power supply 152, which may be one or more rechargeable batteries or some other portable power source, can supply power to the components recited above. As those of skill in the art can appreciate, the power supply 152 can contain voltage regulators and possibly other components for its operation.

In one arrangement, the wireless device 114 may receive at the transceiver 148 a disabling signal from the disablement zone manager 110 through, for example, the communications network 112. In response, the processor 144 can disable one or more features of the wireless device 114. The transceiver 148 may also receive an exemption signal from the disablement zone manager 110, and the processor 144 can reverse or prevent the disablement of the features.

In another arrangement, the wireless device 114 may receive from the disablement zone manager 110 data relating to the disablement zones 126 and the exempt zones 128. This data can be, for example, the coverage area of the disablement zones 126 and the exempt zones 128, which the processor 144 can load into the memory 146. This data can be retrieved later to permit the processor 144 to determine whether the wireless device 114 is in a disablement zone 126 or an exempt zone 128. In yet another arrangement, disablement zones 126 (including the features to be disabled) and exempt zones 128 may be preloaded into the memory 146 of the wireless device 114, such as when the wireless device 114 is manufactured or activated for a consumer.

These processes will be further described below. In addition, those of skill in the art will appreciate that the disablement zone manager 110 and the wireless device 114 (and the wireless tracking device 117) may contain additional components, as compared to those shown in FIG. 3, to allow the disablement zone manager 110 and the wireless device 114 to perform other well-known functions in accordance with well-known principles.

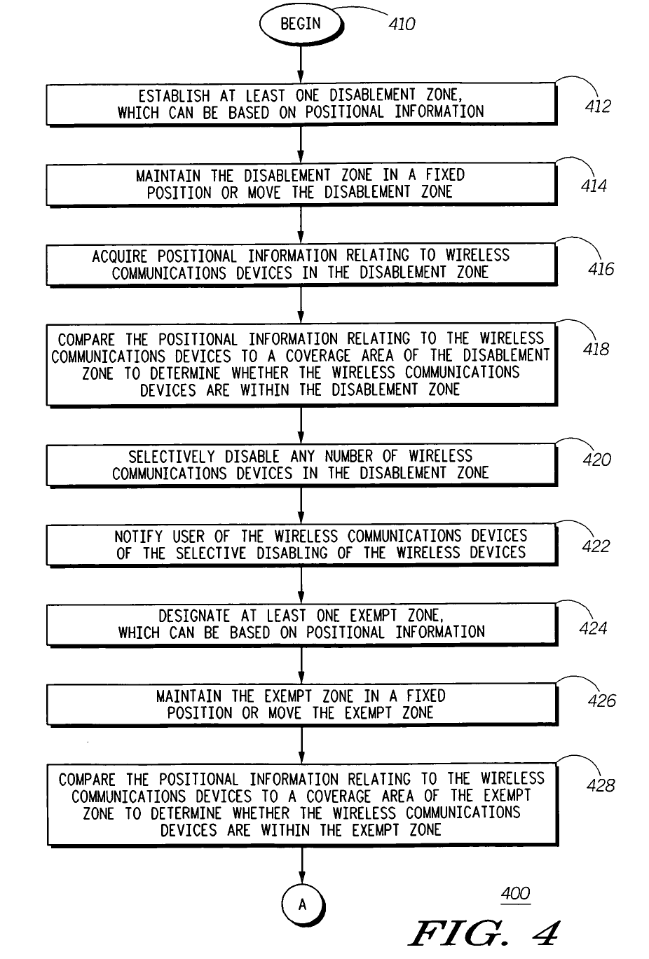

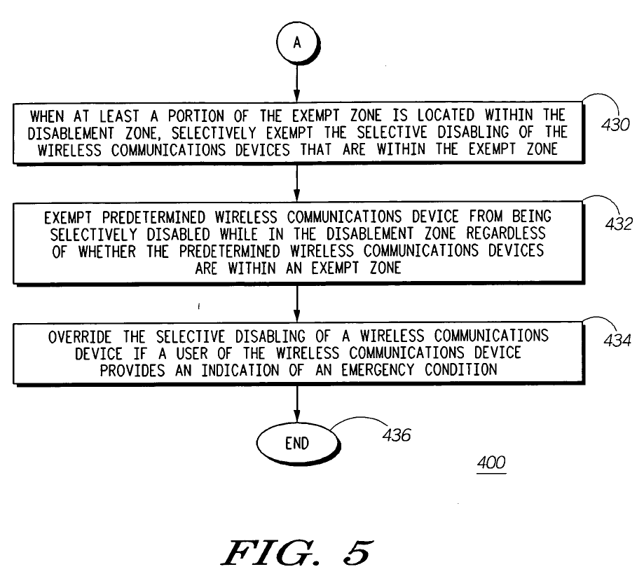

Referring to FIG. 4, a method 400 for providing an adaptive disablement zone is shown. To describe the method 400, reference will be made to FIGS. 1-3, although it is understood that the method 400 can be implemented in any other suitable device or system using other suitable components. Moreover, the invention is not limited to the order in which the steps are listed in the method 400. In addition, the method 400 can contain a greater or a fewer number of steps than those shown in FIGS. 4 and 5.

At step 410, the method 400 can begin. At step 412, at least one disablement zone can be established, which can be based on positional information. At step 414, the disablement zone can be maintained in a fixed position, or the disablement zone can be moved. At step 416, positional information relating to wireless communications devices in the disablement zone can be acquired. The positional information relating to the wireless communications devices can be compared to a coverage area of the disablement zone to determine whether the wireless communications devices are within the disablement zone, as shown at step 418. At step 420, any number of wireless communications devices in the disablement zone can be selectively disabled. Also, at step 422, users of the wireless communications devices can be notified of the selective disabling of the wireless communications devices.

As an example, referring to FIGS. 1-3, the disablement zone manager 110 can establish one or more disablement zones 126. As noted earlier, these disablement zones 126 can be used to inhibit wireless communications within their boundaries. In one arrangement, an authorized person can enter positional information related to selected areas into the computing device 124. For example, the individual may enter an address of a building or area or the positional coordinates (such as GPS coordinates) of a building or an area that can form a disablement zone 126. This building or area may be a place where the user wishes to have wireless communications suppressed or inhibited, such as a school, church or government building.

As another example, the user may select one or more pre-designated grids from a suitable software program in which the chosen grids can define the area where a user wishes to have wireless communications inhibited. In either arrangement, the areas where wireless communications may be suppressed can be changed at any time. A user can simply enter in new information at the computing device 124 to update the affected areas.

As explained above, information concerning the disablement zones 126 can also be pre-loaded into the memory 146 of the wireless device 114, such as at the time of manufacture or consumer activation. Further, a user can enter directly into the wireless device 114 the positional information concerning the areas where it may be desirable to suppress selectively the operation of the wireless device 114. The user may also specify the features that are to be disabled. This data can be entered into the wireless device 114 through, for example, the keypad 160 or the display 162.

The above examples can apply to a fixed disablement zone 126 (while fixed, the disablement zone 126 can be freely updated at any time, however). As noted above, the disablement zone 126 can be movable, such as being positioned around a tracking wireless device 117 embedded in a moving object. As an example, a user can enter into the computing device 124 an identification value associated with a particular tracking wireless device 117 to help the disablement zone manager 110 identify the tracking wireless device 117. The user may also enter in positional information about this tracking wireless device 117, such as the range R of the disablement zone 126 as measured from the tracking wireless device 117. Other parameters or configurations, other than the range R, can be used to determine the area to be covered by the movable disablement zone 126.

There may be certain circumstances where the term positional information may refer to at least two different types of data. For example, for a movable disablement zone 126, the positional information can relate to the operating range of the disablement zone 126, as measured from the wireless tracking device 117. This type of positional information, which may be called operating range positional information, can include the parameters of the movable disablement zone 126. An example of operating range positional information can be the range R that can be used to determine the area to be covered by the movable disablement zone 126, as illustrated in FIG. 2. The user may enter into the computing device 124 the operating range positional information when the user wishes to create a movable disablement zone 126.

Another example of positional information can be the actual physical location of a tracking wireless device 117 that is used to establish a movable disablement zone 126 (see the tracking wireless device 117 in the vehicle 132 of FIG. 2). This example of positional information can include the GPS coordinates of such a tracking wireless device 117 and may be referred to as tracking positional information. For purposes of clarity, the terms operating range positional information and tracking positional information will be used in this document where appropriate. It is understood, however, that the term positional information, if applicable, may be referring to both operating range positional information and tracking positional information.

Whether fixed or movable disablement zones 126 are established, the user may temporally limit the inhibition of wireless communications in the selected areas. For example, the user can select a time period for certain days of the week in which the wireless communications will be affected in the chosen areas. The user may also specify which features of the wireless devices 114 are to be disabled. As an example, the user may be a government official authorized to perform such a selection.

Once entered into the computing device 124, the computing device 124 can transfer the positional information, any temporal restrictions, any identifiers and the features to be disabled to the disablement zone manager 110, through the communications network 122, for example. The communication interface 142 of the disablement zone manager 110 can receive this data and transfer it to the processor 138, which can forward the data to the memory 140 thereby establishing the disablement zones 126. The area of the disablement zone 126 that can be stored in the memory 140 can be referred to as a coverage area.

For the movable disablement zones 126, the disablement zone manager 110 can track the tracking wireless devices 117 that are used to set up the disablement zones 126. The disablement zone manager 110 can receive this tracking positional information from the communications network 112. As an example, such a tracking wireless device 117 may be moving by being embedded in a moving vehicle. Here, the disablement zone manager 110 can create and constantly update a coverage area of the disablement zone 126 by referring to the operating range positional information associated with the disablement zone 126, e.g., the radius R of the disablement zone 126. The actual area covered by the movable disablement zone 126 can be constantly updated by the processor 144 and stored in the memory 140.

During the disablement process, the positional acquiring element 150 of the wireless device 114 can send to the processor 144 positional information relating to the wireless device 114. As explained earlier, the positional information can be GPS coordinates. The processor 144 can instruct the transceiver 148 to transmit this positional information to, for example, the base station 118 currently serving the wireless device 114. The base station 118 can then transfer the positional data to the disablement zone manager 110 through the connection network 120, for example.

Numerous wireless devices 114 can provide this positional information. In addition, the positional information relating to the wireless devices 114 can be provided at predetermined intervals or based on certain events, like when a wireless device 114 is turned on. Those of skill in the art will appreciate, however, that there may be other ways to provide the disablement zone manager 110 with the positional information of the wireless devices 114.

Once it receives the positional information relating to the wireless device 114, the processor 138 of the disablement zone manager 110 can compare this positional information to the coverage area stored in the memory 140 that relates to the disablement zones 126. As an example, the processor 138 can compare the GPS coordinates of the wireless devices 114 to the area(s) covered by the disablement zones 126.

Through this comparison, the processor 138 can determine whether a wireless device 114 is located within a disablement zone 126. If applicable, the processor 138 can also determine whether the disablement zone 126 has any temporal restrictions associated with it. If the processor 138 determines that the wireless device 114 is not in a disablement zone 126 or if the disablement zone 126 is to not be enforced at this particular time, the operation of the wireless device 114 can remain unaffected.

Conversely, if the processor 138 determines that the wireless device 114 is located within the coverage area of a disablement zone 126 (and there are no temporal restrictions currently in place, for example), the processor 138 can generate a disabling signal, which can be sent to the communications network 112 through the communication interface 142. The communications network 112 can then forward the disabling signal to the wireless devices 114 that are in the disabling zones 126.

The transceiver 148 of the wireless device 114 can receive the disabling signal from the disablement zone manager 110 and can forward it to the processor 144. At this point, the processor 144 can selectively disable any number of features of the wireless device 114 based on the disabling signal. In one arrangement, the disabling signal can recite the features of the wireless device 114 that are to be disabled. As an example, the processor 144 can merely deactivate the power supply 152 to prevent the operation of the wireless device 114. As another example, the processor 144 can shut down the transceiver 148, which can prevent the wireless device 114 from receiving or transmitting wireless signals. In yet another example, the processor 144 can deactivate any number of components of the user interface section 154, such as the speaker 156, the microphone 158, the keypad 160 or the display 162. Another example can be where the processor 144 inhibits the receipt of a call but still allows a call to be initiated.

Although the selectively disabling process can typically mean preventing the wireless device 114 from receiving and/or transmitting signals, the invention is not limited in this regard. In fact, the term selectively disabling can mean inhibiting any feature of the wireless device 114 that may prevent the wireless device 114 from being in a fully operational state.

A user of the wireless device 114 can be notified of the selective disablement. Although the notification step may occur after the selective disablement step as shown in FIG. 4, it is understood that the notification process can occur before the wireless device 114 is selectively disabled. For example, if a disabling signal is received, the processor 144 can cause the user to be notified through the speaker 156 and/or the display 162. The user can be notified either before or after the selective disablement of the wireless device 114 is performed. In one scenario, the user may be engaged in some function of the wireless device 114, such as conducting a conversation. The processor 144 can cause the user to be notified of an impending selective disablement of the wireless device 114 a predetermined time before the disablement occurs to give the user an opportunity to complete the function, e.g., end the call.

In another arrangement, once the disablement zone manager 110 establishes the disablement zones 126, the disablement zone manager 110 can forward to the wireless devices 114 via the communications network 112 data relating to the disablement zones 126. For example, the disablement zone manager 110 can forward to the wireless devices 114 the boundaries of the disablement zones 126. As part of the step of establishing the disablement zones 126, the disablement zone manager 110 may also send the features of the wireless device 114 that are to be disabled. The processor 144 can load this data into the memory 146. This process can apply to both fixed disablement zones 126 and movable disablement zones 126. As a reminder, one or more disablement zones 126 may also be pre-loaded into the memory 146 during the wireless device 114 manufacturing or programming process.

The processor 144 can also acquire positional information relating to the location of the wireless device 114 from the positional acquiring element 150. The processor 144 can then compare the positional information of the wireless device 114 to the boundaries or coverage area of the disablement zones 126. If the processor 144 determines that the wireless device 114 is in a disablement zone 126, the processor 144 can selectively disable one or more features of the wireless device 114, as described above. Thus, the determination of whether a wireless device 114 is in a disablement zone 126 can occur in the disablement zone manager 110, the wireless device 114 or any other suitable component.

In view of the above, it can be said that the disablement zone manager 110 can cause the selective disablement of wireless devices 114 in at least two ways: (1) the disablement zone manager 110 can establish disablement zones 126, compare the location of wireless devices 114 to the coverage areas of the disablement zones 126 and signal the wireless devices 114 if it determines that the wireless device 114 is in a disablement zone 126; and (2) the disablement zone manager 110 can establish disablement zones 126 and can forward to the wireless devices 114 data relating to the coverage areas of the disablement zones 126 to permit the wireless device 114 to determine whether it is in a disablement zone 126. Of course, the disablement zone manager 110 may perform other suitable actions to cause the wireless devices 114 to be selectively disabled.

Referring back to FIG. 4, at step 424, at least one exempt zone can be designated, and the exempt zone can be based on positional information. At step 426, the exempt zone can be maintained in a fixed position or the exempt zone can be moved. At step 428, the positional information relating to the wireless communications devices can be compared to a coverage area of the exempt zone to determine whether the wireless communications devices are within the exempt zone. Referring to FIG. 5, at step 430 (through jump circle A), when at least a portion of the exempt zone is located within the disablement zone, the selective disablement of the wireless communications devices that are within the exempt zone can be selectively exempted.

Referring to FIGS. 1-3, the process of creating exempt zones 128, whether fixed or mobile, and the determination of whether a wireless device 114 is contained within an exempt zone 128 can be similar to the process described above in relation to the disablement zones 126. For example, a user, such as an authorized government official, may enter into the computing device 124 the positional coordinates or the address of an area where it may be desirable to minimize or override the effects of a disablement zone 126. As an example, the positional coordinates may be GPS coordinates. The user may also enter the features of the wireless device 114 that are to be exempt from the disabling zone 126.

If the exempt zone 128 is movable (see an example in FIG. 2), the user may also enter into the computing device 124 the operational range positional information of the exempt zone 128, such as the radius R of the exempt zone 128. The computing unit 124 can transfer the positional information to the disablement zone manager 110 over the communications network 122.

Where appropriate, the coverage areas of the exempt zones 128 (including the exempted features) may also be pre-loaded into the memory 146 of the wireless device 114. A user of the wireless device 114 may also enter into the wireless device 114 information concerning the coverage areas (including the exempted features) of the exempt zones 128.

In one arrangement, the processor 138 can designate or create the exempt zones 128, and their coverage areas can be stored in the memory 140. If the exempt zone 128 is movable, the processor 138 can receive tracking positional information relating to an appropriate tracking wireless device 117 by tracking the wireless device 117 through the communications network 112. Through the operational range positional information and the tracking positional information, the processor 138 can create and constantly update the coverage area of the movable exempt zone 128, which can be stored in the memory 140.

The processor 138 can also receive positional information from the wireless devices 114 in accordance with the previous discussion. The processor 138 can then compare the positional information of the wireless devices 114 to the coverage area of the exempt zone 128 to determine whether a wireless device 114 is in an exempt zone 128.

If at least a portion of an exempt zone 128 is located within a disablement zone 126, the processor 138 of the disablement zone manager 110 may forego the sending of a disabling signal to the wireless devices 114 in the exempt zone 128. The processor 138 may avoid sending the disabling signal even though the wireless device 114 would normally be sitting in a disablement zone 126.

As another alternative, if a wireless device 114 was originally positioned in a disablement zone 126 and had been selectively disabled, the selective disablement can be reversed. For example, the processor 138 may generate an exemption signal and can cause this signal to be transmitted to the wireless device 114 if the wireless device 114 enters the coverage area of an exempt zone 128. Once it receives the signal, the wireless device 114 may return to normal functionality, at least while it is within the exempt zone 128.

Referring to FIG. 2, several examples will be discussed. The wireless device 114 located in the fixed exempt zone 128 may not be affected by the movable disablement zone 126. Similarly, any wireless devices 114 that may be within the vehicle 136, which is enveloped within the movable exempt zone 128, may be unaffected by the movable disablement zone 126.

Although the reversal or prevention of the selective disablement of a wireless device 114 may include returning or keeping the wireless device 114 at full functionality, it must be noted that the invention is not so limited. For example, while in an exempt zone 128, certain features of the wireless device 114 may be maintained or reactivated while others may remain or be disabled. As an example, if a wireless device 114 is in an exempt zone 128 and would normally be within the range of a disablement zone 126, the wireless device 114 may not be permitted to engage in a wireless conversation. The wireless device 114, however, may be permitted to send and receive text messages while in the exempt zone 128. Of course, the invention is not so limited, as other examples are within contemplation of the inventive arrangements.

Like the discussion relating to the disablement zones 126, the disablement zone manager 110 can forward data relating to the exempt zones 128 to the wireless devices 114. The processor 144, after it obtains positional information from the positional acquiring element 150, can determine if the wireless device 114 is in the exempt zone 128. If it is, the processor 144 can take certain steps to selectively prevent or reverse the disablement of the wireless device 114.

As a result, the disablement zone manager 110 can also cause a wireless device 114 to be exempted from being selectively disabled in at least two ways: (1) the disablement zone manager 110 can establish exempt zones 128, compare the location of wireless devices 114 to the coverage areas of the exempt zones 128 and signal the wireless devices 114 if it determines that the wireless device 114 is in an exempt zone 128; and (2) the disablement zone manager 110 can establish exempt zones 128 and can forward to the wireless devices 114 data relating to the coverage areas of the exempt zones 128 to permit the wireless device 114 to determine whether it is in an exempt zone 126. Of course, the disablement zone manager 110 may perform other suitable actions to cause the wireless devices 114 to be exempt from the selective disablement process.

Referring back to the method 400 of FIG. 5, at step 432, predetermined wireless communications devices can be exempt from being selectively disabled while in the disablement zone regardless of whether the predetermined wireless communications devices are within an exempt zone. In addition, at step 434, the selective disabling of a wireless communications device can be overridden if a user of the wireless communications device provides an indication of an emergency condition. At step 436, the method 400 can end.

Referring to FIGS. 1-3 again, certain wireless devices 114 can be exempt from the selective disabling process regardless of whether the wireless device 114 is in an exempt zone 128. For example, it may be desirable to prevent the selective disabling of wireless devices 114 assigned to emergency personnel, government officials or some other privileged users. These wireless devices 114 can be registered, for example, at the computing device 124. The computing device 124 can transfer data identifying these wireless devices 114 to the disablement zone manager 110 through the communications network 122. The identifying data can be an electronic serial number (ESN) or a mobile identification number (MIN) of the wireless device 114, for example. A user can also perform the registration process directly through the wireless device 114, is so desired.

The processor 138 of the disablement zone manager 110 can receive the identifying data and can store it in the memory 140. The processor 138 can access the identifying data to determine whether to exempt a wireless device 114 from the selective disablement process. If a wireless device 114 has been previously registered, the processor 138 can avoid sending a disabling signal to the wireless device 114 when the wireless device 114 is in a disablement zone 126 regardless of whether the wireless device 114 is in an exempt zone 128. Alternatively, if a wireless device 114 has been registered, the processor 144 of the wireless device 114 can be programmed to ignore any disabling signals from the communications network 112 or any other suitable component or system.

In another arrangement, if a user's wireless device 114 has been selectively disabled, the selective disablement can be overridden if the user provides an indication of an emergency condition. As an example, a user may dial 911 or some other emergency-related number on the keypad 160 of the wireless device 114. In response, the processor 144 (if necessary) can signal the disablement zone manager 110 through the communications network 112 that the selective disablement is to be overridden. The processor 144 can then return the wireless device 114 to its previous state, or at least a condition that can permit the wireless device 114 to complete the emergency call. Of course, the invention is not limited to this example, as the user can perform other acts that can provide the indication of an emergency condition.

Where applicable, the present invention can be realized in hardware, software or a combination of hardware and software. Any kind of computer system or other apparatus adapted for carrying out the methods described herein are suitable. A typical combination of hardware and software can be a mobile communication device with a computer program that, when being loaded and executed, can control the mobile communication device such that it carries out the methods described herein. The present invention can also be embedded in a computer program product, which comprises all the features enabling the implementation of the methods described herein and which when loaded in a computer system, is able to carry out these methods.

While the preferred embodiments of the invention have been illustrated and described, it will be clear that the invention is not so limited. Numerous modifications, changes, variations, substitutions and equivalents will occur to those skilled in the art without departing from the spirit and scope of the present invention as defined by the appended claims.

What is claimed is:

1. A method for providing an adaptive disablement zone, comprising:
establishing at least one disablement zone;
selectively disabling any number of wireless communications devices in the disablement zone;
designating at least one exempt zone; and
when at least a portion of the exempt zone is located within the disablement zone, selectively exempting the selective disabling of the wireless communications devices that are within the exempt zone.

2. The method according to claim 1, further comprising acquiring positional information relating to the wireless communications devices in the disablement zone.

3. The method according to claim 2, wherein the establishing at least one disablement zone step further comprises establishing the disablement zone based on positional information and the method further comprises comparing the positional information relating to the wireless communications devices to a coverage area of the disablement zone to determine whether the wireless communications devices are within the disablement zone.

4. The method according to claim 2, wherein the designating at least one exempt zone step further comprises designating the exempt zone based on positional information and the method further comprises the step of comparing the positional information relating to the wireless communications devices to a coverage area of the exempt zone to determine if the wireless communications devices are within the exempt zone.

5. The method according to claim 1, further comprising at least one of:
maintaining the disablement zone in a fixed position; and
moving the disablement zone.

6. The method according to claim 1, further comprising at least one of:
maintaining the exempt zone in a fixed position; and
moving the exempt zone.

7. The method according to claim 1, further comprising exempting predetermined wireless communications devices from being selectively disabled while in the disablement zone regardless of whether the predetermined wireless communications devices are within an exempt zone.

8. The method according to claim 7, wherein the predetermined wireless communications devices that are exempted are assigned to at least one of government officials and emergency personnel.

9. The method according to claim 1, further comprising notifying users of the wireless communications devices of the selective disabling of the wireless communications devices.

10. The method according to claim 1, further comprising overriding the selective disabling of a wireless communications device if a user of the wireless communications provides an indication of an emergency condition.

11. A disablement zone manager, comprising:
a communication interface for permitting the disablement zone manager to communicate with a communications network; and
a processor coupled to the communication interface, wherein the processor is programmed to:
establish at least one disablement zone;
cause via the communications network through the communication interface the selective disablement of any number of wireless communications devices in the disablement zone;
designate at least one exempt zone; and
cause via the communications network through the communication interface the selective exemption of the selective disabling of the wireless communications devices that are within the exempt zone when at least a portion of the exempt zone is located within the disablement zone.

12. The disablement zone manager according to claim 11, wherein the processor is further programmed to receive positional information relating to the wireless communications devices in the disablement zone.

13. The disablement zone manager according to claim 12, further comprising a memory and wherein the processor is further programmed to:
establish the disablement zones based on positional information, wherein the positional information is stored in the memory; and
compare the positional information relating to the wireless communications devices to a coverage area of the disablement zones to determine whether the wireless communications devices are within the disablement zone.

14. The disablement zone manager according to claim 12, further comprising a memory and wherein the processor is further programmed to:
designate the exempt zones based on positional information, wherein the positional information is stored in the memory; and
compare the positional information relating to the wireless communications devices to a coverage area of the exempt zones to determine if the wireless communications devices are within the exempt zones.

15. The disablement zone manager according to claim 11, wherein the disablement zone is one of at least a fixed disablement zone and a movable disablement zone.

16. The disablement zone manager according to claim 11, wherein the exempt zone is one of at least a fixed exempt zone and a movable exempt zone.

17. The disablement zone manager according to claim 11, wherein the processor is further programmed to cause predetermined wireless communications devices to be exempted from being selectively disabled while in the disablement zone regardless of whether the predetermined wireless communications devices are within an exempt zone.

18. The disablement zone manager according to claim 11, wherein the processor is further programmed to cause users of the wireless communications devices to be notified of the selective disabling of their wireless communications devices.

19. The system according to claim 11, wherein the selective disabling of a wireless communications device is overridden if a user of the wireless communications device provides an indication of an emergency condition.

20. A system for providing an adaptive disablement zone, comprising:
a disablement zone manager; and
a communications network coupled to the disablement zone manager;
wherein the communications network services wireless communications devices;
wherein the disablement zone manager:
establishes at least one disablement zone;
signals the communications network to cause the selective disablement of any number of wireless communications devices in the disablement zone;
designates at least one exempt zone; and
when at least a portion of the exempt zone is located within the disablement zone, signals the communications network to cause the selective exemption of the selective disabling of the wireless communications devices that are within the exempt zone.

21. A wireless communications device, comprising:
a transceiver, wherein the transceiver communicates with a communications network;
a positional acquiring element, wherein the positional acquiring element acquires positional information relating to the wireless communications device; and
a processor coupled to the transceiver and the positional acquiring element, wherein the processor is programmed to:
determine when the wireless communications unit is in a disablement zone;
in response, selectively disable at least one feature of the wireless communications device;
determine when the wireless communications device is in an exempt zone; and
in response, selectively exempt the selective disabling of the features of the wireless communications device.
